(19) United States
(12) Patent Application Publication
(10) Pub. No.: US 2015/0098825 A1
(43) Pub. Date: Apr. 9, 2015

(54) BEARING ARRANGEMENT

(71) Applicants: Hans Wendeberg, Vastra Frolunda (SE); Linus Efraimsson, Askim (SE)

(72) Inventors: Hans Wendeberg, Vastra Frolunda (SE); Linus Efraimsson, Askim (SE)

(21) Appl. No.: 14/396,619

(22) PCT Filed: Apr. 17, 2013
(86) PCT No.: PCT/SE2013/000053

§ 371 Date: Oct. 23, 2014

(30) Foreign Application Priority Data
Apr. 23, 2012 (SE) 1200241-6

(51) Int. Cl. F03D 11/00; F16C 33/58; F16C 41/00; F16C 33/46; F16C 19/36

(52) U.S. Cl. CPC F03D 11/0008; F16C 33/4605; F16C 19/364; F16C 19/361; F16C 41/004; F16C 33/586
USPC 416/174; 384/572; 384/564

(57) ABSTRACT

A bearing arrangement, comprising a rolling bearing, which includes an inner ring, an outer ring, rolling elements interposed therebetween, and a cage for holding and separating the rolling elements, wherein the inner ring presents an inner circumferential surface. A shaft is also present, wherein the rolling bearing is mounted on the shaft via the inner circumferential surface of the inner ring. The shaft during operation is meant to oscillate in its axial direction, or is positioned in an angle α being (90−y) degrees, wherein y is between 0 and 89, or the rolling elements during operation are exposed of an axial force F, and the cage presents means for axially guiding the rolling elements against at least one of the inner ring, the outer ring or a separate element located outside the rolling bearing. The bearing can be integrated into a wind turbine main shaft arrangement.

### CROSS REFERENCE TO RELATED APPLICATIONS

This is a National Stage application claiming the benefit of International Application Number PCT/SE2013/000053, filed on 17 Apr. 2013 (Apr. 17, 2013), which claims priority to Sweden Patent Application 1200241-6, filed on 23 Apr. 2012 (Apr. 23, 2012), both of which are is incorporated herein by reference in their entireties.

### FIELD OF THE INVENTION

According to a first aspect, the invention regards a bearing arrangement.

According to a second aspect, the invention regards a wind turbine main shaft arrangement.

### BACKGROUND OF THE INVENTION

Bearings, such as rolling bearings, are used to support rotating shafts and to accommodate loads in radial and/or axial directions.

There are numerous of applications where bearings are used, such as in automotive industry, in industrial applications, such as wind turbines, paper mills, steel making industry etc.

Some concerns with different bearing arrangements in different applications have been discovered by the inventors. These concerns have been shown to be caused by e.g. the cage in the bearing. Rolling elements in a bearing which are in an unloaded zone may be affected by the cage in a negative way. The rollers or balls, when in an unloaded zone, may for instance be braked by the cage, which will lead to roller/ball slip. Roller/ball slip is something that should be avoided because the lubrication film that is needed between the rolling elements and the bearing's raceways is disturbed or even vanished when the slip becomes too large. This may lead to a reduction in the service life. Another effect that may arise for roller elements in its unloaded zone is roller skew, caused by e.g. the cage, which may lead to increased friction in the bearing, increased unwanted forces on the cage or increased wear of the bearing components. Yet another effect that may arise for rolling elements in its unloaded zone is that the rolling elements are moved in its axial direction. This may lead to noise and damages on the surfaces of the rolling elements and the raceways.

### SUMMARY OF THE INVENTION

An object of the invention is to overcome at least one of the problems of the prior art.

According to the first aspect, the object is achieved by a bearing arrangement, wherein the bearing arrangement comprises: a rolling bearing, wherein the rolling bearing comprises an inner ring, an outer ring and rolling elements interposed between the inner and outer ring, a cage for holding and separating the rolling elements, and wherein said inner ring presents an inner circumferential surface. Furthermore, the bearing arrangement comprises a shaft , wherein the rolling bearing is mounted on the shaft via the inner circumferential surface of the inner ring, and wherein the shaft during operation is meant to oscillate in its axial direction, or wherein the shaft is positioned in an angle α being (90−y) degrees, wherein y is between 0 and 89, or wherein the rolling elements during operation are exposed of an axial force F, and, wherein the cage presents means for axially guiding the rolling elements against at least one of the inner ring, the outer ring or a separate element located outside the rolling bearing. The angle a is an angle relative a horizontal line.

Due to this design, the rolling elements will be axially guided and keep the rolling elements in position in their loaded and unloaded zone during operation of the bearing. It has namely been found by the inventors that when size and thus the weight of the rolling elements is large, it is especially advantageous to guide the rolling elements axially by the cage against one of the bearing rings. Especially if the bearing is mounted on a non-horizontal shaft or in circumstances when the rolling elements are exposed of axial forces there has been found to be a need for guiding the rolling elements in a way keeping them in position both when being in a loaded and unloaded condition. In an alternative embodiment, a separate element, such as a ring, may be used as a corresponding guiding element for the cage. The ring may for instance be positioned axially outside the bearing. The axial force F acting on the rolling elements is in an embodiment of a magnitude such that the rolling elements tend to move in an axial direction.

In this document, the words axial and radial are used. If not stated differently for any of the presented embodiments of the invention, it refers to the geometry of the bearing arrangement, the rolling bearing and the shaft. Axial means a direction following an imaginary line that intersect the center points of the cage, the rolling bearing and the shaft and that is perpendicular to a radial direction of the bearing and the cage. Radial means a radial direction of the bearing and the cage that origin from the center points of the bearing and the cage.

In an embodiment of the bearing arrangement, the rolling bearing is a roller bearing. In a further embodiment, the roller bearing is any of a toroidal roller bearing, a tapered roller bearing, a spherical roller bearing, a spherical roller thrust bearing or a cylindrical roller bearing. The rolling bearing may also be any kind of ball bearing.

In another embodiment of the bearing arrangement, the rolling bearing is a non-locating bearing. If the bearing arrangement comprises a second bearing, one bearing may be a locating bearing and the other may be a non-locating bearing. A locating bearing is a bearing that locates and fixes the shaft axially, wherein a non-locating bearing is a bearing that mainly or only is meant to accommodate radial forces. A non-locating bearing may for instance be a bearing wherein the bearing rings can be axially displaced relative each other, but it can also be a bearing that is fitted onto the shaft in a way so it can move and be displaced axially on the shaft. Thus, a non-locating bearing would benefit of having a cage with means that can guide the rolling elements axially against the inner, outer ring or a separate element in the situations as described above, i.e. when an axial force is acting on the rolling elements, when the shaft is non-horizontal or when an axial oscillation of the shaft is present.

In an embodiment of the bearing arrangement, the rolling bearing is a large rolling bearing with an external diameter of at least 500 mm. It has been found by the inventors that increased size and thus weight of the rolling elements leads to an increased need of guiding the rolling elements axially against one of the bearing rings or a separate element located outside the bearing. This is especially the case when the bearing is mounted on a non-horizontal axle, which will lead to that the gravitation force acting on the rolling elements will result in an axial force vector, and not only a radial force vector.

In an embodiment of the bearing arrangement, the means is at least one portion on the cage extending in a radial direction towards at least one of the outer ring, inner ring or the separate element.

In an embodiment of the bearing arrangement, at least one of the outer ring, inner ring or separate element presents at least one surface extending in a circumferential direction of the outer ring, inner ring or separate element, wherein the surface is meant to be able to receive the means to thereby axially guide the rolling elements. In a further embodiment, the at least one surface is located on at least one axial end of the inner and/or outer ring.

In a further embodiment, the at least one surface in its axial extension is: inclined, stepped, concave or convex. The surface shall have any shape that can create an axial opposite force component acting on the means for axially guiding the rolling elements in the bearing.

In an embodiment, the bearing arrangement is used in a pod propulsion system for a marine vessel. In another embodiment, a pod propulsion arrangement for a marine vessel is presented, wherein a bearing arrangement according to any of the embodiments above is included.

According to the second aspect of the invention, the object is achieved by a wind turbine main shaft arrangement, wherein the wind turbine comprises: the bearing arrangement according to any of the above embodiments, a generator rotatably connected to the shaft at a first position of the shaft and means for absorbing wind energy connected to the shaft at a second position on the shaft. The means are preferably at least one rotor blade connected to the shaft for absorbing wind energy. The rolling bearing is located on the shaft between the first and the second position and the shaft is positioned in an angle α being (90−y) degrees from a horizontal line of the wind turbine, wherein y is between 0 and 89.

The inventors have realized that a bearing during operation, such as a main bearing, in a wind turbine would benefit of having an axial guidance of the rolling elements against one of the bearing's rings or against a separate element. In other words, the cage will be ring-centered instead of roller/ball centered which is otherwise often the case. This design is advantageous due to the fact that most wind turbines are designed such that the main shaft of the wind turbine is located in a non-horizontal position. The main shaft has this configuration because the rotor blades of the wind turbine are angled out from the tower of the wind turbine in order to avoid that the blades of the rotor will collide into the tower. The rolling elements of the bearing will be kept in a central position of the bearing both when being in a loaded and unloaded condition due to that the rolling elements are axially guided by the cage via the bearing's rings, or an external separate ring. This will thus e.g. minimize rolling friction, reduce roller skew and prevent excessive axial movement of the rolling elements, in particular the unloaded rolling elements.

For larger wind turbines which requires larger bearings this is especially advantageous because increased weight of the rolling elements increases the risk of axial displacement of the rolling elements in their unloaded zone. In an embodiment, a large rolling bearing is above 500 mm in its outer diameter.

In an embodiment, the wind turbine shaft is vertically mounted. There are wind turbine designs which have a vertical shaft with rotor blades.

It shall be noted that all embodiments of the first aspect are applicable to all embodiments of the second aspect and vice versa.

In an embodiment of the wind turbine, the shaft is positioned in an angle α being any of: 1 degree, 2 degrees, 3 degrees, 4 degrees, 5 degrees, 6 degrees, 7 degrees, 8 degrees, 9 degrees or 10 degrees, or any angle in-between these angles from a horizontal line of the wind turbine.

In another embodiment, a second rolling bearing is located between the first and second position at a distance from the first rolling bearing. This bearing may for instance be a locating or a non-locating bearing. A locating bearing is able to accommodate axial forces from the rotor shaft.

In another embodiment, there is only one rolling bearing on the main shaft of the wind turbine. In such a case, the bearing is able to accommodate both axial and radial forces. For instance, the bearing may be a toroidal roller bearing which further comprises an additional roller row integrated in the bearing which can accommodate axial forces. The additional row could for instance be located between one of the two bearing rings and an additional third bearing ring.

In an embodiment, the means for axially guiding the rolling elements of the bearing is located on one axial side of the bearing. More specifically, in an embodiment the means are located on the axial side of the bearing that is located in a vertically higher position than the other axial side of the bearing as a consequence of the non-horizontal shaft.

In another embodiment of the invention, a gear box is located between the shaft and the generator. One or more bearings may be integrated in the gear box. Furthermore, such bearing may be configured to accommodate both axial and radial forces, i.e. be a locating bearing on the main shaft.

### BRIEF DESCRIPTION OF DRAWINGS

Below, a more detailed description of a number of preferred embodiments will be described. It should be noted that the accompanying drawings are not drawn to scale, and in some cases specific details may have been exaggerated in order to better explain the invention. Furthermore, the invention as claimed is not limited to the embodiments described and shown, but modifications are possible for a skilled person within the scope of the claims.

FIG. 1 is a schematic cross sectional view of an example of a bearing arrangement according to the invention.

FIG. 2 is a schematic cross sectional view of an example of another bearing arrangement according to the invention.

FIG. 3 is a schematic cross sectional view of an embodiment of a wind turbine main shaft arrangement according to the invention.

FIG. 4 is a schematic cross sectional view of a wind turbine main shaft arrangement according to the invention, which is located in a nacelle of a wind turbine.

### DETAILED DESCRIPTION OF THE PRESENT INVENTION

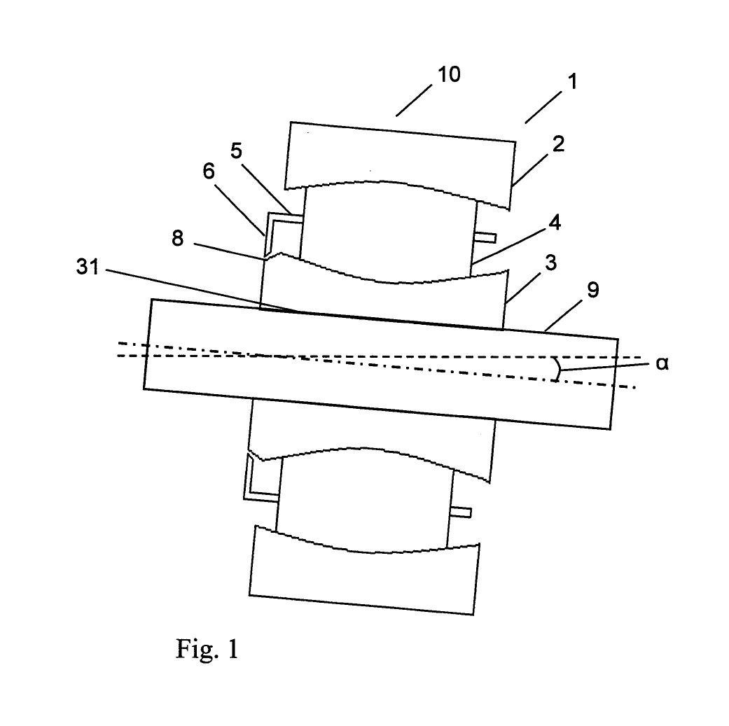

FIG. 1 discloses a schematic cross sectional view of an embodiment of a bearing arrangement 10 according to the invention. The cross sectional view is a cross section of a plane along an axial line of the bearing 1. The bearing arrangement 10 comprises a rolling bearing 1. In this illustrated embodiment, the rolling bearing 1 is a toroidal roller bearing. However, the bearing can be any other type of rolling bearing, such as a ball bearing, a spherical roller bearing, a tapered roller bearing, a cylindrical roller bearing, a spherical thrust roller bearing etc. Toroidal roller bearings are known for its ability to be able to both axially and angularly displace the inner and outer rings relative each other. This function is advantageous in many applications, such as for instance in a wind turbine, a paper mill, in steel making industry etc. The design of the toroidal roller bearing, wherein the curved profile of the raceways' and the rollers' radii is substantially larger than the radial distance from the center axis to the center of each raceway, leads to this functionality. The rolling bearing 1 comprises an outer ring 2, an inner ring 3, a plurality of rolling elements 4 interposed between the outer 2 and inner 3 ring. A cage 5 holds and separates the rolling elements 4 from each other. The cage presents a means 6 for axially guiding the rolling elements 4 against the inner ring 3 of the bearing 1. The means 6 in this embodiment is a portion 6 of the cage 5 which extends radially towards a surface 8 of the inner ring 3. The surface 8 is further in this embodiment an inclined surface. In this illustration, the portion 6 is located in an axial position outside the outer ring 2. It shall be recognized that the portion 6 in another embodiment may be positioned axially inside the axial width of the outer ring 3. The surface 8 shall be of a shape such that an axial opposing force can act towards the portion 6 of the cage 5 when the portion 6 and the surface 8 are in contact. The surface 8 can also be located in other locations, such as on the outer ring 2 and/or on the other axial side of the bearing 1. Further, in this embodiment is one portion 6 shown, but the cage 5 can of course have several portions 6, directed towards the outer ring 2 and also on the other axial side of the bearing 1. The bearing arrangement 10 also comprises a shaft 9. In this illustration, the shaft 9 is positioned in an angle α degrees from a horizontal line. Due to that the bearing 1 is mounted onto a non-horizontal shaft 9, the rolling elements 4 will tend to move axially especially in their unloaded zone. Due to that the cage presents a portion 6 that axially guides the rolling elements 4 against the inner ring 3, the rolling elements will be kept in a centered position even in the unloaded zone. Other examples of when it is advantageous to have a bearing with this design is when the shaft oscillates in an axial direction and when there is an axial force acting on the rolling elements, wherein the force is large enough to be able to axially displace the rolling elements.

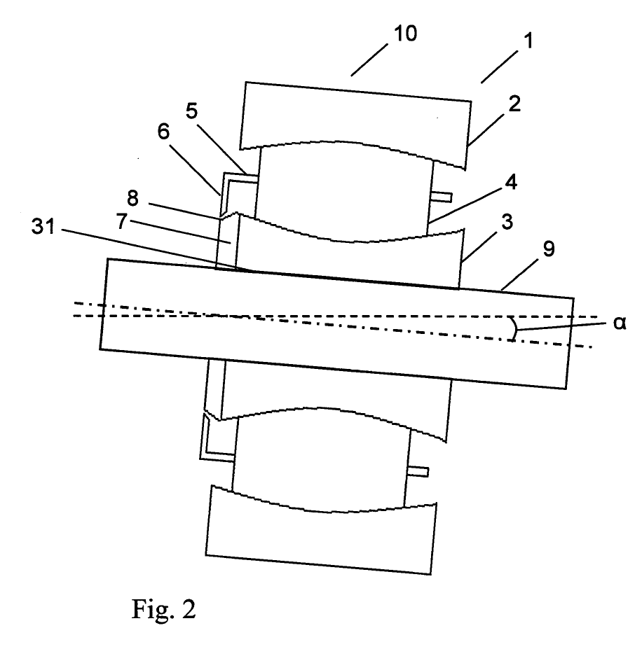

FIG. 2 discloses a schematic cross sectional view of another embodiment of a bearing arrangement 10 according to the invention. The cross sectional view is a cross section of a plane along an axial line of the bearing 1. The bearing arrangement 10 comprises a rolling bearing 1. In this embodiment, the rolling bearing 1 is a toroidal roller bearing. However, the bearing can be any other type of rolling bearing, such as a ball bearing, a spherical roller bearing, a tapered roller bearing, a cylindrical roller bearing, a spherical thrust roller bearing etc. The rolling bearing 1 comprises an outer ring 2, an inner ring 3, a plurality of rolling elements 4 interposed between the outer 2 and inner 3 ring. A cage 5 holds and separates the rolling elements 4 from each other. The cage presents a means 6 for axially guiding the rolling elements 4 against a separate ring 7 of the bearing 1. The separate ring 7 is mounted on the shaft 9 and located next to the inner ring 3. The means 6 in this embodiment is a portion 6 of the cage 5 which extends radially towards a surface 8 of the separate ring 7. The surface 8 is further in this embodiment an inclined surface. The surface 8 shall be of a shape such that an axial opposing force can act towards the portion 6 of the cage 5 when the portion 6 and the surface 8 are in contact. The ring 7 can also be located in other positions, such as on the other axial side of the bearing 1. It can also be located next to the outer ring 2. Furthermore, there can be several rings 7 around the bearing 1. Further, in this embodiment is one portion 6 shown, but the cage 5 can of course have several portions 6, directed towards the outer ring 2 and also on the other axial side of the bearing 1. In this illustration, the portion 6 is located in an axial position outside the outer ring 2. It shall be recognized that the portion 6 in another embodiment may be positioned axially inside the axial width of the outer ring 3. The bearing arrangement 10 also comprises a shaft 9. In this illustration, the shaft 9 is positioned in an angle α degrees from a horizontal line. Due to that the bearing 1 is mounted onto a non-horizontal shaft 9, the rolling elements 4 will tend to move axially especially in their unloaded zone. Due to that the cage presents a portion 6 that axially guides the rolling elements 4 against the inner ring 3, the rolling elements will be kept in a centered position even in the unloaded zone. Other examples of when it is advantageous to have a bearing with this design is when the shaft oscillates in an axial direction and when there is an axial force acting on the rolling elements, wherein the force is large enough to be able to axially displace the rolling elements.

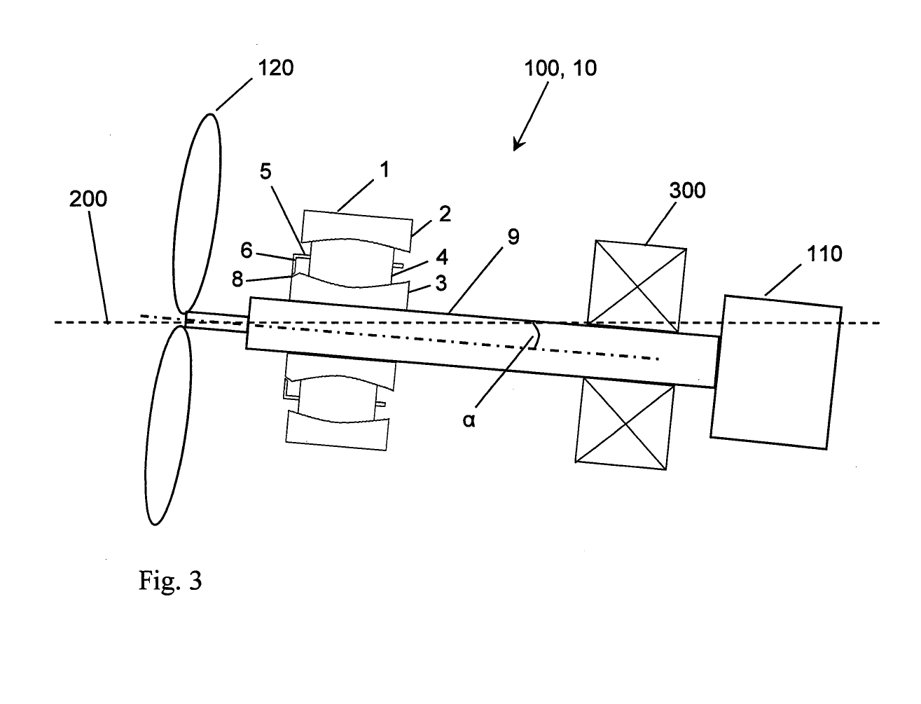

FIG. 3 discloses a schematic cross sectional view of an embodiment of a wind turbine main shaft arrangement 100 according to the invention. The cross sectional view is a cross section of a plane along an axial line of the main shaft arrangement 100. The wind turbine main shaft 100 comprises a bearing arrangement 10, rotor blades 120 and a generator 110. Furthermore, the wind turbine main shaft arrangement most often also includes a gear box (not shown) between the main shaft 9 and the generator 110. The main shaft 9 transfers the rotation of the rotor blades to the generator 110 to thereby convert a rotational kinetic energy to electricity. The bearing arrangement 10 comprises a first rolling bearing 1 and a second rolling bearing 300 that supports the main shaft 9 and wherein the bearings 1 and 300 are mounted into a nacelle of the wind turbine (not shown). The rolling bearing 1 comprises an outer ring 2, an inner ring 3, a plurality of rolling elements 4 interposed between the outer 2 and inner 3 ring. A cage 5 holds and separates the rolling elements 4 from each other. The cage presents a means 6 for axially guiding the rolling elements 4 against the inner ring 3 of the bearing 1. The means 6 in this embodiment is a portion 6 of the cage 5 which extends radially towards a surface 8 of the inner ring 3. The surface 8 is further in this embodiment an inclined surface. The surface 8 shall be of a shape such that an axial opposing force can act towards the portion 6 of the cage 5 when the portion 6 and the surface 8 are in contact. The rolling bearing 1 is in this embodiment a toroidal roller bearing, but any other bearing can also be used, as described above. The other bearing 300 is in this embodiment most preferably a locating bearing that can accommodate both radial and axial loads. For instance, the bearing 300 can be a spherical roller bearing. The bearings 1 and 300 are located at a distance from each other. In an embodiment, the bearings 1 and 300 have a distance between each other which is substantially zero. In another embodiment, the bearings 1 and 300 are integrated into each other. In a further embodiment, only one bearing is supporting the shaft, wherein that bearing presents a means 6 for axially guiding the rolling elements 4 against at least one of the inner ring 3, outer ring 2 or a separate ring. In a further embodiment, the second bearing 300 is integrated into the gear box (not shown). In a further embodiment, the rolling bearing 1 is integrated into the gearbox of the wind turbine. The wind turbine main shaft arrangement 100 is located in a non-horizontal position, which is indicated by the angle α in the figure. It is very common to arrange a main shaft 9 like this in order to avoid that the blades 120 of the rotor will collide with the tower of the wind turbine (not shown).

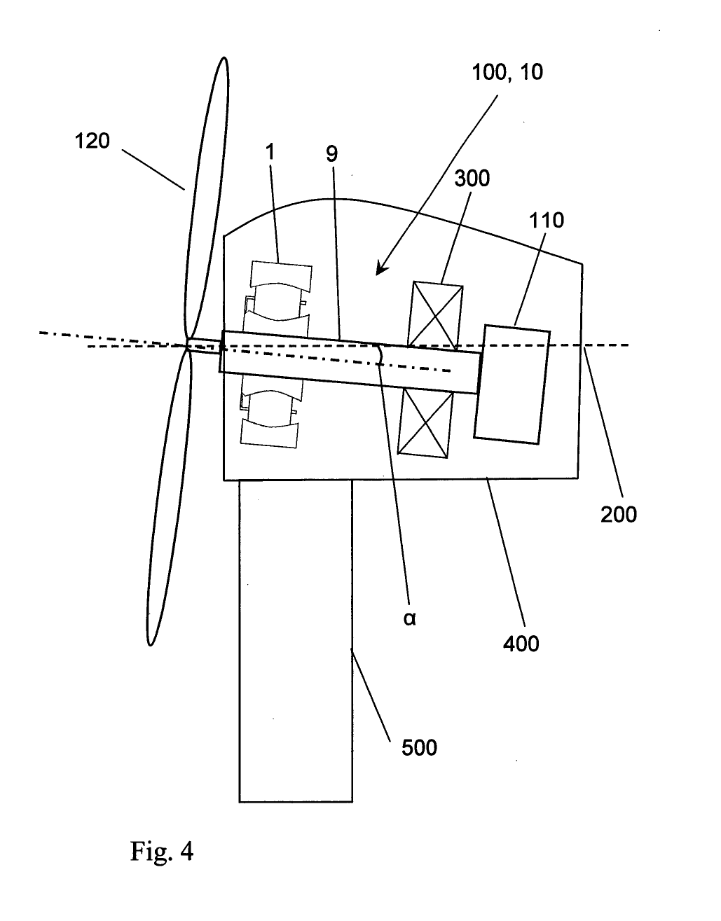

FIG. 4 shows a schematic cross sectional view of an embodiment of a wind turbine main shaft arrangement 100 in a wind turbine according to the invention. The cross sectional view is a cross section of a plane along an axial line of the main shaft arrangement 100. The wind turbine main shaft 100 comprises a bearing arrangement 10, rotor blades 120 connected to the main shaft via a hub (not shown) and a generator 110. Furthermore, the wind turbine main shaft arrangement most often also includes a gear box (not shown) between the main shaft 9 and the generator 110. The main shaft 9 transfers the rotation of the rotor blades to the generator 110 to thereby convert a rotational kinetic energy to electricity. The bearing arrangement 10 comprises a first rolling bearing 1 and a second rolling bearing 300 that supports the main shaft 9 and wherein the bearings 1 and 300 are mounted into a nacelle 400 of the wind turbine. Furthermore, the nacelle 400 is located and supported by a tower 500. The rolling bearing 1 is designed as in any of the embodiments of the rolling bearing 1 above. The other bearing 300 is in this embodiment most preferably a locating bearing that can accommodate both radial and axial loads. For instance, the bearing 300 can be a spherical roller bearing. The wind turbine main shaft arrangement 100 is located in a non-horizontal position in the nacelle 400, which is indicated by the angle α in the figure. The angle α may for instance be any of 1, 2, 3, 4, 5, 6, 7, 8, 9, 10 degrees or any angle in-between these angles. It is very common to arrange a main shaft 9 like this in order to avoid that the blades 120 of the rotor will collide with the tower 500 of the wind turbine.

1. A bearing arrangement, comprising,
a rolling bearing, wherein the rolling bearing comprises includes an inner ring, an outer ring, rolling elements, wherein the rolling elements are interposed between the inner and outer rings, and a cage for holding and separating the rolling elements, wherein the inner ring presents an inner circumferential surface, and
a shaft, wherein the rolling bearing is mounted on the shaft via the inner circumferential surface of the inner ring,
wherein one of:
(a) the shaft, during operation, is meant to oscillate in its axial direction, or
(b) the shaft is positioned in an angle α being (90−y) degrees, wherein y is between 0 and 89, or
(c) the rolling elements during operation are exposed of an axial force F, and
wherein the cage includes an axial guiding feature for axially guiding the rolling elements against at least one of the inner ring, the outer ring or a separate element located outside the rolling bearing.

2. The bearing arrangement according to claim 1, wherein the rolling bearing is a roller bearing.

3. The bearing arrangement according to claim 2, wherein the roller bearing is any of:
(a) a toroidal roller bearing,
(b) a tapered roller bearing,
(c) a spherical roller bearing or
(d) a cylindrical roller bearing.

4. The bearing arrangement according to claim 1, wherein the rolling bearing is a non-locating bearing.

5. The bearing arrangement according to claim 1, wherein the rolling bearing is a large rolling bearing with an external diameter of at least 500 mm.

6. The bearing arrangement according to claim 1, wherein the axial guiding feature is at least one portion of the cage extending in a radial direction towards at least one of the outer ring, the inner ring or the separate element.

7. The bearing arrangement according to claim 1,
wherein at least one of the outer ring, the inner ring and the separate element presents at least one surface extending in a circumferential direction of the outer ring, the inner ring and the separate element, wherein the surface is adapted to receive the axial guiding feature to thereby axially guide the rolling elements.

8. The bearing arrangement according to claim 7, wherein the at least one surface is located on at least one axial end of at least one of the inner and outer ring.

9. The bearing arrangement according to claim 7,
wherein the at least one surface in its axial extension is:
inclined,
stepped,
concave, or
convex.

10. A wind turbine main shaft arrangement, comprising,
the bearing arrangement comprising:
a rolling bearing, wherein the rolling bearing includes an inner ring, an outer ring, rolling elements, wherein the rolling elements are interposed between the inner and outer rings, and a cage for holding and separating the rolling elements, wherein the inner ring presents an inner circumferential surface, and
a shaft, wherein the rolling bearing is mounted on the shaft via the inner circumferential surface of the inner ring,
wherein one of:
(a) the shaft, during operation, is meant to oscillate in its axial direction, or
(b) the shaft is positioned in an angle α being (90−y) degrees, wherein y is between 0 and 89, or
(c) the rolling elements during operation are exposed of an axial force F, and
wherein the cage includes an axial guiding feature for axially guiding the rolling elements against at least one of the inner ring, the outer ring or a separate element located outside the rolling bearing;
a generator rotatably connected to the shaft at a first position of the shaft,
a wind energy absorbing feature for absorbing wind energy, wherein the wind energy absorbing feature is connected to the shaft at a second position of the shaft,
wherein the rolling bearing is located on the shaft between the first and second position, and
wherein the shaft is positioned in an angle α being (90−y) degrees from a horizontal line of the wind turbine, wherein y is between 0 and 89.

11. The wind turbine main shaft arrangement according to claim 10,
wherein the shaft is positioned in an angle α being any of:
1 degree, 2 degrees, 3 degrees, 4 degrees, 5 degrees, 6 degrees or 7 degrees or any angle between these angles from a horizontal line of the wind turbine.

12. The wind turbine main shaft arrangement according to claim 10, wherein a second rolling bearing is located between the first and second position at a distance from the first rolling bearing.

13. The wind turbine main shaft arrangement according to claim 12, wherein the second bearing is a locating bearing able to accommodate axial forces.
